(19) United States
(12) Patent Application Publication
(10) Pub. No.: US 2005/0267724 A1
(43) Pub. Date: Dec. 1, 2005

(54) Record medium recording equivalent circuit model of electricity storage element, derivation program, record medium thereof, derivation apparatus, simulation program, record medium thereof, simulation apparatus, method of designing, method for conforming/nonconforming decision, and conforming/nonconforming decision apparatus

(75) Inventors: Kazuya Niki, Osaka (JP); Osamu Moriya, Ikoma-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SANYO ELECTRIC CO., LTD., Moriguchi-shi (JP)

(21) Appl. No.: 11/130,242

(22) Filed: May 17, 2005

(30) Foreign Application Priority Data
May 26, 2004 (JP) 2004-156472(P)
Jul. 28, 2004 (JP) 2004-220614(P)

(51) Int. Cl. G06F 17/50

(52) U.S. Cl. 703/14

(57) ABSTRACT

A computer-readable record medium, recording an equivalent circuit model of an electricity storage element wherein a real part of an equivalent impedance varies to approximate to a real part of a measured impedance according to a frequency of an applied AC signal, records the equivalent circuit model including a first circuit corresponding to an electricity storage unit and a second circuit corresponding to a terminal unit and connected in series with the first circuit, wherein the first circuit includes at least one series circuit including a first parallel circuit and a second parallel circuit connected in series, the first parallel circuit includes a first resistance and a first inductance connected in parallel with the first resistance, and the second parallel circuit includes a second resistance and a capacitance connected in parallel with the second resistance.

### BACKGROUND OF THE INVENTION

1. Field of the Invention

The present invention relates to a simulation technique for an electric circuit and, more specifically, to an equivalent circuit model of an electricity storage element.

2. Description of the Background Art

Electric characteristics of an electric circuit in electronic equipment are very important because they determine performance of the electronic equipment.

During designing of the electric circuit, it is difficult to predict the electric characteristics at a stage of a circuit diagram. Conventionally, the designing is carried out by trial and error in which the circuit is actually assembled to measure the electric characteristics and, if desired electric characteristics are not obtained, a new design is made.

Since such manner of designing is not efficient, a prediction of the electric characteristics is generally made in these days using a simulation apparatus including a computer and software.

To perform a simulation as such, a circuit model of an electric circuit must be constructed using an equivalent circuit model of each circuit element forming the electric circuit.

Therefore, a highly accurate equivalent circuit model is needed to efficiently design a circuit. Japanese Patent Laying-Open No. 2002-259482 describes a method including the steps of measuring real parts and imaginary parts of impedances for multiple sample frequencies, and then deriving an equivalent circuit model including a multistage LCR circuit.

A characteristic of the real part of the impedance, that is, a so-called ESR (Equivalent Series Resistance) is important in a capacitor used in a power supply circuit or the like.

It is because, the smaller the ESR is, the smaller a power supply capacity can be and the smaller a ripple of the power supply becomes.

For this reason, Japanese Patent Laying-Open No. 2003-329715 describes a method of evaluating a capacitor with measuring a separated ESR.

Since electronic equipment performs high-speed digital processing and operates at a higher frequency in recent years, a simulation in a high frequency range has been required.

On the other hand, it became apparent that the ESR of a capacitor increases in the high frequency range and a property as the capacitor is degraded.

Therefore, a highly accurate equivalent circuit model considering the characteristic of the ESR is required to perform the simulation in the high frequency range.

FIG. 1 shows a conventional three-element equivalent circuit model.

Since the conventional three-element equivalent circuit model shown in FIG. 1 merely has a resistance R10 connected in series with an inductance L10 and a capacitance C10, however, the ESR becomes a constant value regardless of a frequency.

FIG. 2 shows frequency characteristics obtained when the conventional three-element equivalent circuit model is applied to a Solid Electrolytic Capacitor with Polymerized Organic Semiconductor, in comparison with measured values.

FIG. 2A shows a comparison of frequency characteristics of the ESR.

FIG. 2B shows a comparison of frequency characteristics of absolute values of impedances.

Though absolute values of impedances can be approximated to measured values as shown in FIG. 2B, real parts of impedances cannot be approximated, as shown in FIG. 2A.

In addition, a method of selecting the equivalent circuit model formed with a multistage ladder circuit and a method of deriving each circuit constant are not clear in the method disclosed in Japanese Patent Laying-Open No. 2002-259482 described above.

Therefore, since a highly accurate equivalent circuit model for a capacitor cannot be obtained, a simulation in a high frequency range cannot be performed precisely and an unexpected problem may occur when an electric circuit is actually fabricated.

### SUMMARY OF THE INVENTION

Accordingly, an object of the present invention is to provide a computer-readable record medium recording a highly accurate equivalent circuit model.

Another object of the present invention is to provide a program for allowing a computer to execute derivation of a highly accurate equivalent circuit model.

A further object of the present invention is to provide a record medium recording a program for allowing a computer to execute derivation of a highly accurate equivalent circuit model.

A further object of the present invention is to provide a program for allowing a computer to execute a simulation of electric characteristics of an electric circuit having a capacitor using a highly accurate equivalent circuit model of the capacitor.

A further object of the present invention is to provide a record medium recording a program for allowing a computer to execute a simulation of electric characteristics of an electric circuit having a capacitor using a highly accurate equivalent circuit model of the capacitor.

A further object of the present invention is to provide a method of designing a capacitor using a highly accurate equivalent circuit model of the capacitor.

A further object of the present invention is to provide a method of making a conforming/nonconforming decision for a capacitor using a highly accurate equivalent circuit model of the capacitor.

A further object of the present invention is to provide an apparatus for deriving a highly accurate equivalent circuit model.

A further object of the present invention is to provide an apparatus for performing a simulation of electric characteristics of an electric circuit having a capacitor using a highly accurate equivalent circuit model of the capacitor.

A further object of the present invention is to provide an apparatus for making a conforming/nonconforming decision for a capacitor using a highly accurate equivalent circuit model of the capacitor.

The present invention provides a computer-readable record medium recording an equivalent circuit model of an electricity storage element wherein a real part of an equivalent impedance varies to approximate to a real part of a measured impedance according to a frequency of an applied AC signal; wherein the equivalent circuit model includes a first circuit corresponding to an electricity storage unit and a second circuit corresponding to a terminal unit and connected in series with the first circuit; the first circuit includes at least one first series circuit including a first parallel circuit and a second parallel circuit connected in series; the first parallel circuit includes a first resistance and a first inductance connected in parallel with the first resistance; and the second parallel circuit includes a second resistance and a first capacitance connected in parallel with the second resistance.

The first circuit preferably includes one first series circuit.

Preferably, the first circuit further includes a second series circuit connected in parallel with the first series circuit, and the second series circuit includes a third resistance and a second capacitance connected in series with the third resistance.

The second circuit preferably includes a second inductance and a fourth resistance connected in series with the second inductance.

In addition, the present invention provides a program to be executed by a computer for derivation of an equivalent circuit model of an electricity storage element wherein a real part of an equivalent impedance varies to approximate to a real part of a measured impedance according to a frequency of an applied AC signal; wherein the equivalent circuit model includes a first circuit corresponding to an electricity storage unit and a second circuit corresponding to a terminal unit and connected in series with the first circuit; the first circuit includes at least one first series circuit including a first parallel circuit and a second parallel circuit connected in series; the first parallel circuit includes a first resistance and an inductance connected in parallel with the first resistance; the second parallel circuit includes a second resistance and a first capacitance connected in parallel with the second resistance; and the program allows a computer to execute the steps of accepting a frequency characteristic of the real part of the measured impedance of the electricity storage element, and optimizing each value of an element forming the first circuit to approximate a frequency characteristic of the real part of the equivalent impedance of the equivalent circuit model to the frequency characteristic of the real part of the measured impedance.

The step of optimizing preferably includes a first step of varying respective values of the first resistance, the second resistance, the inductance and the first capacitance, a second step of calculating a frequency characteristic of the real part of the equivalent impedance of the equivalent circuit model using varied values of the first resistance, the second resistance, the inductance and the first capacitance, and a third step of repeating the first step and the second step until the calculated frequency characteristic of the real part of the equivalent impedance approximates to the frequency characteristic of the real part of the measured impedance of the electricity storage element.

Preferably, the first circuit includes one first series circuit and a second series circuit connected in parallel with the first series circuit, the second series circuit includes a third resistance and a second capacitance connected in series with the third resistance, and the step of optimizing includes a first step of varying respective values of the first resistance, the second resistance, the third resistance, the inductance, the first capacitance, and the second capacitance, a second step of calculating a frequency characteristic of the real part of the equivalent impedance of the equivalent circuit model using varied values of the first resistance, the second resistance, the third resistance, the inductance, the first capacitance, and the second capacitance, and a third step of repeating the first step and the second step until the calculated frequency characteristic of the real part of the equivalent impedance approximates to the frequency characteristic of the real part of the measured impedance of the electricity storage element.

In addition, the present invention provides a program to be executed by a computer for a simulation of electric characteristics of an electric circuit having an electricity storage element using an equivalent circuit model of the electricity storage element wherein a real part of an equivalent impedance varies to approximate to a real part of a measured impedance according to a frequency of an applied AC signal; wherein the equivalent circuit model includes a first circuit corresponding to an electricity storage unit and a second circuit corresponding to a terminal unit and connected in series with the first circuit; the first circuit includes at least one first series circuit including a first parallel circuit and a second parallel circuit connected in series; the first parallel circuit includes a first resistance and an inductance connected in parallel with the first resistance; the second parallel circuit includes a second resistance and a first capacitance connected in parallel with the second resistance; and the program allows a computer to execute the steps of accepting a circuit model of the electric circuit including the equivalent circuit model of the electricity storage element, accepting a simulation condition, calculating the electric characteristics based on the circuit model of the electric circuit and the simulation condition, and outputting the calculated electric characteristics.

Preferably, the first circuit includes one first series circuit and a second series circuit connected in parallel with the first series circuit, and the second series circuit includes a third resistance and a second capacitance connected in series with the third resistance.

In addition, the present invention provides a method of designing an electricity storage element to set electric characteristics of an electric circuit having the electricity storage element to desired electric characteristics using an equivalent circuit model of the electricity storage element wherein a real part of an equivalent impedance varies to approximate to a real part of a measured impedance according to a frequency of an applied AC signal; wherein the equivalent circuit model includes a first circuit corresponding to an electricity storage unit and a second circuit corresponding to a terminal unit and connected in series with the first circuit; the first circuit includes at least one first series circuit including a first parallel circuit and a second parallel circuit connected in series; the first parallel circuit includes a first resistance and an inductance connected in parallel with the first resistance; the second parallel circuit includes a second resistance and a first capacitance connected in parallel with the second resistance; and the method includes the steps of: making a circuit model of the electric circuit including the equivalent circuit model of the electricity storage element; determining the desired electric characteristics; optimizing each value of an element forming the first circuit to approximate the electric characteristics of the circuit model of the electric circuit to the desired electric characteristics; and manufacturing the electricity storage element based on each optimized value of the element forming the first circuit.

The step of optimizing preferably includes a first step of varying respective values of the first resistance, the second resistance, the inductance and the first capacitance, a second step of calculating the electric characteristics of the circuit model of the electric circuit using varied values of the first resistance, the second resistance, the inductance and the first capacitance, and a third step of repeating the first step and the second step until the calculated electric characteristics of the circuit model of the electric circuit approximate to the desired electric characteristics.

Preferably, the first circuit includes one first series circuit and a second series circuit connected in parallel with the first series circuit, the second series circuit includes a third resistance and a second capacitance connected in series with the third resistance, and the step of optimizing includes a first step of varying respective values of the first resistance, the second resistance, the third resistance, the inductance, the first capacitance, and the second capacitance, a second step of calculating the electric characteristics of the circuit model of the electric circuit using varied values of the first resistance, the second resistance, the third resistance, the inductance, the first capacitance, and the second capacitance, and a third step of repeating the first step and the second step until the calculated electric characteristics of the circuit model of the electric circuit approximate to the desired electric characteristics.

In addition, the present invention provides a method of making a conforming/nonconforming decision for an electricity storage element using an equivalent circuit model of the electricity storage element wherein a real part of an equivalent impedance varies to approximate to a real part of a measured impedance according to a frequency of an applied AC signal; wherein the equivalent circuit model includes a first circuit corresponding to an electricity storage unit and a second circuit corresponding to a terminal unit and connected in series with the first circuit; the first circuit includes at least one first series circuit including a first parallel circuit and a second parallel circuit connected in series; the first parallel circuit includes a first resistance and an inductance connected in parallel with the first resistance; the second parallel circuit includes a second resistance and a first capacitance connected in parallel with the second resistance; and the method includes the steps of: obtaining a frequency characteristic of the real part of the measured impedance of the electricity storage element; optimizing each value of an element forming the first circuit to approximate a frequency characteristic of the real part of the equivalent impedance of the equivalent circuit model to the frequency characteristic of the real part of the measured impedance; and deciding that the electricity storage element is a conforming item if each optimized value of the element forming the first circuit is within a predetermined range.

The step of optimizing preferably includes a first step of varying respective values of the first resistance, the second resistance, the inductance and the first capacitance, a second step of calculating a frequency characteristic of the real part of the equivalent impedance of the equivalent circuit model using varied values of the first resistance, the second resistance, the inductance and the first capacitance, and a third step of repeating the first step and the second step until the calculated frequency characteristic of the real part of the equivalent impedance approximates to the frequency characteristic of the real part of the measured impedance of the electricity storage element.

Preferably, the first circuit includes one first series circuit and a second series circuit connected in parallel with the first series circuit, the second series circuit includes a third resistance and a second capacitance connected in series with the third resistance, and the step of optimizing includes a first step of varying respective values of the first resistance, the second resistance, the third resistance, the inductance, the first capacitance, and the second capacitance, a second step of calculating a frequency characteristic of the real part of the equivalent impedance of the equivalent circuit model using varied values of the first resistance, the second resistance, the third resistance, the inductance, the first capacitance, and the second capacitance, and a third step of repeating the first step and the second step until the calculated frequency characteristic of the real part of the equivalent impedance approximates to the frequency characteristic of the real part of the measured impedance of the electricity storage element.

In addition, the present invention provides an apparatus for deriving an equivalent circuit model of an electricity storage element wherein a real part of an equivalent impedance varies to approximate to a real part of a measured impedance according to a frequency of an applied AC signal; wherein the equivalent circuit model includes a first circuit corresponding to an electricity storage unit and a second circuit corresponding to a terminal unit and connected in series with the first circuit; the first circuit includes at least one first series circuit including a first parallel circuit and a second parallel circuit connected in series; the first parallel circuit includes a first resistance and an inductance connected in parallel with the first resistance; the second parallel circuit includes a second resistance and a first capacitance connected in parallel with the second resistance; and the apparatus includes a portion for accepting a frequency characteristic of the real part of the measured impedance of the electricity storage element, and a portion for optimizing each value of an element forming the first circuit to approximate a frequency characteristic of the real part of the equivalent impedance of the equivalent circuit model to the frequency characteristic of the real part of the measured impedance.

The portion for optimizing preferably includes a first portion for varying respective values of the first resistance, the second resistance, the inductance and the first capacitance and a second portion for calculating a frequency characteristic of the real part of the equivalent impedance of the equivalent circuit model using varied values of the first resistance, the second resistance, the inductance and the first capacitance; the first portion and the second portion repeat operations until the calculated frequency characteristic of the real part of the equivalent impedance approximates to the frequency characteristic of the real part of the measured impedance of the electricity storage element.

Preferably, the first circuit includes one first series circuit and a second series circuit connected in parallel with the first series circuit, the second series circuit includes a third resistance and a second capacitance connected in series with the third resistance, and the portion for optimizing includes a first portion for varying respective values of the first resistance, the second resistance, the third resistance, the inductance, the first capacitance, and the second capacitance, a second portion for calculating a frequency characteristic of the real part of the equivalent impedance of the equivalent circuit model using varied values of the first resistance, the second resistance, the third resistance, the inductance, the first capacitance, and the second capacitance; the first portion and the second portion repeat operations until the calculated frequency characteristic of the real part of the equivalent impedance approximates to the frequency characteristic of the real part of the measured impedance of the electricity storage element.

In addition, the present invention provides an apparatus for performing a simulation of electric characteristics of an electric circuit having an electricity storage element using an equivalent circuit model of the electricity storage element wherein a real part of an equivalent impedance varies to approximate to a real part of a measured impedance according to a frequency of an applied AC signal; wherein the equivalent circuit model includes a first circuit corresponding to an electricity storage unit and a second circuit corresponding to a terminal unit and connected in series with the first circuit; the first circuit includes at least one first series circuit including a first parallel circuit and a second parallel circuit connected in series; the first parallel circuit includes a first resistance and an inductance connected in parallel with the first resistance; the second parallel circuit includes a second resistance and a capacitance connected in parallel with the second resistance; and the apparatus includes a portion for accepting a circuit model of the electric circuit including the equivalent circuit model, a portion for accepting a simulation condition, a portion for calculating the electric characteristics based on the circuit model of the electric circuit and the simulation condition, and a portion for outputting the calculated electric characteristics.

Preferably, the first circuit includes one first series circuit and a second series circuit connected in parallel with the first series circuit, and the second series circuit includes a third resistance and a second capacitance connected in series with the third resistance.

In addition, the present invention provides an apparatus for making a conforming/nonconforming decision for an electricity storage element using an equivalent circuit model of the electricity storage element wherein a real part of an equivalent impedance varies to approximate to a real part of a measured impedance according to a frequency of an applied AC signal, wherein the equivalent circuit model includes a first circuit corresponding to an electricity storage unit and a second circuit corresponding to a terminal unit and connected in series with the first circuit, the first circuit includes at least one first series circuit including a first parallel circuit and a second parallel circuit connected in series, the first parallel circuit includes a first resistance and an inductance connected in parallel with the first resistance, the second parallel circuit includes a second resistance and a first capacitance connected in parallel with the second resistance, and the apparatus includes a portion for obtaining a frequency characteristic of the real part of the measured impedance of the electricity storage element, a portion for optimizing each value of an element forming the first circuit to approximate a frequency characteristic of the real part of the equivalent impedance of the equivalent circuit model to the frequency characteristic of the real part of the measured impedance, and a portion for deciding that the electricity storage element is a conforming item if each optimized value of the element forming the first circuit is within a predetermined range.

The portion for optimizing preferably includes a first portion for varying respective values of the first resistance, the second resistance, the inductance and the first capacitance, a second portion for calculating a frequency characteristic of the real part of the equivalent impedance of the equivalent circuit model using varied values of the first resistance, the second resistance, the inductance and the first capacitance; the first portion and the second portion repeat operations until the calculated frequency characteristic of the real part of the equivalent impedance approximates to the frequency characteristic of the real part of the measured impedance of the electricity storage element.

Preferably, the first circuit includes one first series circuit and a second series circuit connected in parallel with the first series circuit, the second series circuit includes a third resistance and a second capacitance connected in series with the third resistance, and the portion for optimizing includes a first portion for varying respective values of the first resistance, the second resistance, the third resistance, the inductance, the first capacitance, and the second capacitance, a second portion for calculating a frequency characteristic of the real part of the equivalent impedance of the equivalent circuit model using varied values of the first resistance, the second resistance, the third resistance, the inductance, the first capacitance, and the second capacitance; the first portion and the second portion repeat operations until the calculated frequency characteristic of the real part of the equivalent impedance approximates to the frequency characteristic of the real part of the measured impedance of the electricity storage element.

Since a highly accurate equivalent circuit model of a capacitor can be obtained according to the present invention, a precise simulation especially in a high frequency range is enabled.

In addition, since an equivalent circuit model corresponding to a structure of a capacitor can be obtained according to the present invention, a correspondence with the structure of the capacitor is clear and therefore efficient designing of a capacitor having a desired characteristic is enabled.

Furthermore, since a product can be evaluated using an equivalent circuit model derived from an ESR of each sample frequency according to the present invention, a conforming/nonconforming decision for the product can be made rapidly with a low cost without measuring electric characteristics of a whole frequency range.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a conventional three-element equivalent circuit model.

FIGS. 2A and 2B show frequency characteristics obtained when the conventional three-element equivalent circuit model is applied to a Solid Electrolytic Capacitor with Polymerized Organic Semiconductor, in comparison with measured values.

FIG. 3 shows an equivalent circuit model according to a first embodiment of the present invention.

FIG. 4 is a schematic construction view of a computer for executing a program according to the first embodiment of the present invention.

FIG. 5 is a flow chart of a program for deriving the equivalent circuit model according to the first embodiment of the present invention.

FIGS. 6A and 6B show frequency characteristics obtained when the equivalent circuit model according to the first embodiment of the present invention is applied to a Solid Electrolytic Capacitor with Polymerized Organic Semiconductor, in comparison with measured values.

FIGS. 7A and 7B show examples of other equivalent circuit models.

FIG. 8 shows an equivalent circuit model according to an improved example of the first embodiment of the present invention.

FIG. 9 is a flow chart of a program for deriving the equivalent circuit model according to the improved example of the first embodiment of the present invention.

FIGS. 10A and 10B show frequency characteristics obtained when the equivalent circuit model according to the improved example of the first embodiment of the present invention is applied to a Solid Electrolytic Capacitor with Polymerized Organic Semiconductor, in comparison with measured values.

FIG. 11 shows an example of another equivalent circuit model.

FIGS. 12A and 12B show an example of an electric circuit having a capacitor according to a second embodiment of the present invention.

FIG. 13 is a flow chart of a program for performing a simulation of the electric circuit having the capacitor according to the second embodiment of the present invention.

FIGS. 14A and 14B show an example of an electric circuit having a capacitor according to an improved example of the second embodiment of the present invention.

FIG. 15 is a flow chart of a program for designing a capacitor according to a third embodiment of the present invention.

FIG. 16 is a schematic construction view of an apparatus for making a conforming/nonconforming decision for a capacitor according to a fourth embodiment of the present invention.

FIG. 17 is a flow chart of a program for making the conforming/nonconforming decision for the capacitor according to the fourth embodiment of the present invention.

FIG. 18 is a flow chart of a program for making a conforming/nonconforming decision for a capacitor according to an improved example of the fourth embodiment of the present invention.

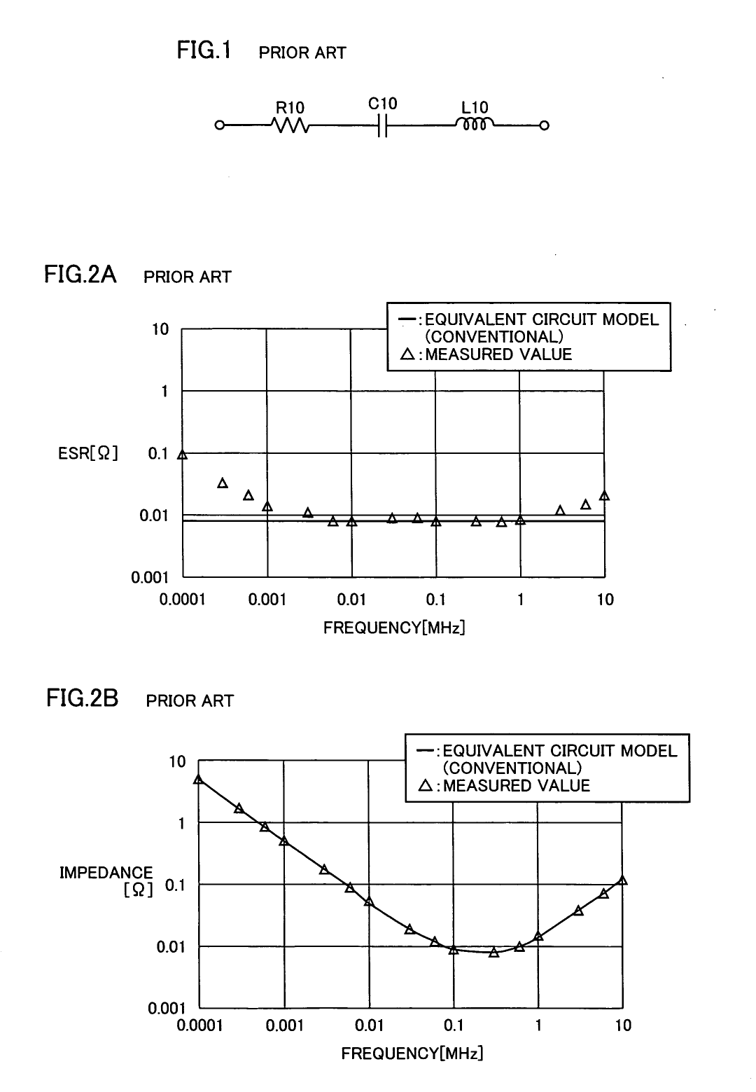

### DESCRIPTION OF THE PREFERRED EMBODIMENTS

Embodiments of the present invention will now be described in detail referring to the drawings. It is to be noted that, the same or corresponding portions in the drawings are indicated with the same characters and the descriptions thereof will not be repeated.

### First Embodiment

A program for allowing a computer to execute derivation of an equivalent circuit model of a capacitor according to a first embodiment of the present invention will now be described.

The equivalent circuit model of the capacitor will first be described.

As shown in FIG. 2A, a measured ESR increases on high frequency and low frequency sides. Since a degree of such increase differs for each capacitor, an equivalent circuit model is adopted which can flexibly vary an ESR characteristic by varying a value of each element forming the circuit.

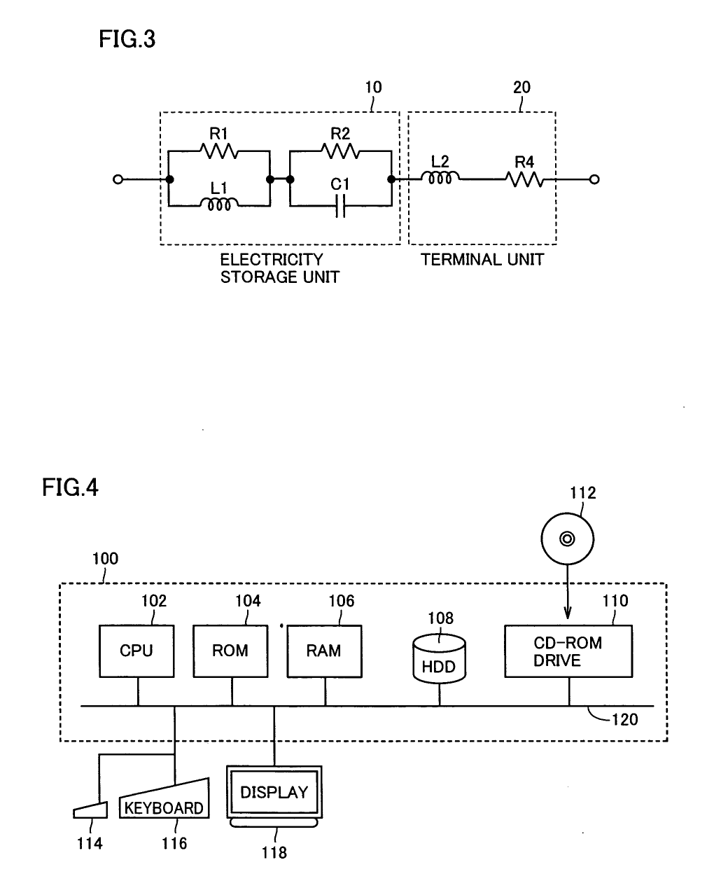

Referring to FIG. 3, the equivalent circuit model according to the first embodiment of the present invention consists of a circuit 10 corresponding to an electricity storage unit and a circuit 20 corresponding to a terminal unit.

Circuit 10 is formed with a parallel circuit of a resistance R1 and an inductance L1 and a parallel circuit of a resistance R2 and a capacitance C1, which are connected in series with each other.

Circuit 20 is formed with an inductance L2 and a resistance R4 connected in series.

The following expression (1) is an expression for calculating an impedance of the equivalent circuit model shown in FIG. 3.

$$Z = R4 + \frac{{ω}^{2} {L1}^{2} R1}{{R1}^{2} + {ω}^{2} {L1}^{2}} + \frac{R2}{1 + {ω}^{2} {C1}^{2} {R2}^{2}} + j ω ( L2 + \frac{{L1R1}^{2}}{{R1}^{2} + {ω}^{2} {L1}^{2}} - \frac{{C1R2}^{2}}{1 + {ω}^{2} {C1}^{2} {R2}^{2}} ) \qquad [ Expression 1 ]$$

where j represents an imaginary unit.

A current flowing into the parallel circuit of resistance R1 and inductance L1 in circuit 10 is divided in proportion to a ratio of reciprocals of impedances of resistance R1 and inductance L1. An impedance of inductance L1 is proportional to a frequency. Therefore, in a low frequency range, inductance L1 has a low impedance and a ratio of the current flowing through inductance L1 is large, and therefore an ESR of the whole parallel circuit is small. On the other hand, since the impedance of inductance L1 becomes higher as the frequency becomes higher, the ratio of the current flowing through resistance R1 increases and the ESR of the whole parallel circuit increases.

Accordingly, the ESR characteristic in the high frequency range can be varied with values of resistance R1 and inductance L1 of the parallel circuit.

On the other hand, a current flowing into the parallel circuit of resistance R2 and capacitance C1 in circuit 10 is divided in proportion to a ratio of reciprocals of impedances of resistance R2 and capacitance C I. An impedance of capacitance C1 is inversely proportional to a frequency. Therefore, in a high frequency range, capacitance C1 has a low impedance and a ratio of the current flowing through capacitance C1 is large, and therefore an ESR of the whole parallel circuit is small. On the other hand, since the impedance of capacitance C1 becomes higher as the frequency becomes lower, the ratio of the current flowing through resistance R2 increases and the ESR of the whole parallel circuit increases.

Accordingly, the ESR characteristic in the low frequency range can be varied with values of resistance R2 and capacitance C1 of the parallel circuit.

Since circuit 20 is formed with inductance L2 and resistance R4 connected in series, an ESR thereof is R4 regardless of frequencies.

Therefore, the ESR characteristic can be approximated to measured values in the whole frequency range by, after determining resistance R4 using measured values in the whole frequency range, optimizing values of resistance R1 and inductance L1 mainly using measured values in the high frequency range and optimizing values of resistance R2 and capacitance C1 mainly using measured values in the low frequency range.

Next, the program for allowing a computer to execute derivation of the equivalent circuit model of the capacitor will be described.

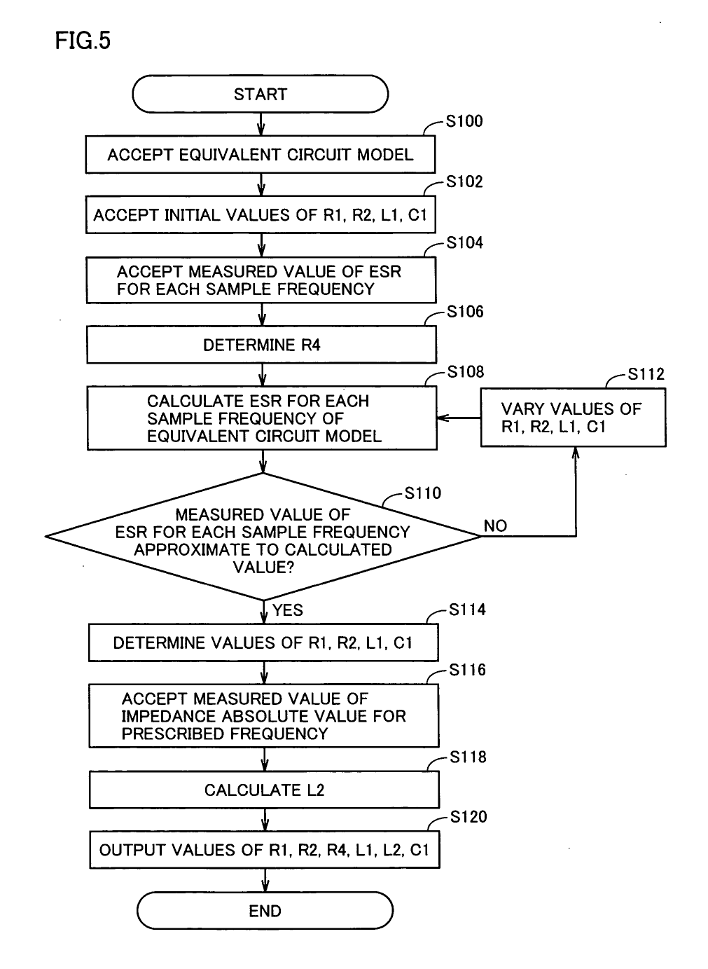

Referring to FIG. 4, a mouse 114, a keyboard 116 and a display 118 are connected to computer 100.

Computer 100 includes a CPU (Central Processing Unit) 102, an ROM (Read Only Memory) 104 storing a program or the like to be sent to an operating system, an RAM (Random Access Memory) 106 for loading the program to be executed and storing data during execution of the program, a hard disk (HDD) 108, and a CD-ROM (Compact Disc Read Only Memory) drive 110, which are respectively connected to a bus 120. A CD-ROM 112 is mounted on CD-ROM drive 110.

Computer 100 executes processing of each step shown in FIG. 5 with the program for deriving the equivalent circuit model executed in CPU 102.

The program is generally stored in a record medium such as CD-ROM 112 for distribution, read from the record medium with CD-ROM drive 110 or the like, and temporarily stored in hard disk 108. The program is further read from hard disk 108 into RAM 106 and executed by CPU 102.

Referring to FIG. 5, CPU 102 accepts an equivalent circuit model input by a user (step S100). The user allows the equivalent circuit model stored in CD-ROM 112 to be read from CD-ROM drive 110, and constructs the equivalent circuit model on display 118 using keyboard 116 and mouse 114.

Then, CPU 102 accepts initial values of resistances R1, R2, inductance L1 and capacitance C1 of the equivalent circuit model input by the user (step S102). The user inputs the initial values of resistances R1, R2, inductance L1 and capacitance C1 using keyboard 116 and mouse 114. The initial values are used in an optimization process described below, and can be arbitrarily determined by the user.

CPU 102 further accepts a measured value of an ESR for each sample frequency input by the user (step S104). The user measures the ESR for each of a plurality of sample frequencies for the capacitor as an object beforehand and inputs the measured value using keyboard 116 and mouse 114. The larger a number of measured ESR is, the more accuracy of the equivalent circuit model increases.

After input from the user is completed, CPU 102 determines a value of resistance R4 (step S106). When a real part of expression (1) for calculation of the impedance, that is, the ESR is noted, R4 does not depend on ω. Therefore, resistance R4 can be calculated from the sample frequency and the measured ESR value.

Then, CPU 102 performs the optimization process for circuit 10 corresponding to the electricity storage unit to approximate an ESR frequency characteristic calculated using the equivalent circuit model to a measured ESR frequency characteristic. The optimization process will be described in the following.

CPU 102 calculates the ESR for each sample frequency of the equivalent circuit model corresponding to the sample frequency for which the ESR was measured (step S108).

Then, CPU 102 determines as to whether the measured value of the ESR for each sample frequency is approximate to the calculated value (step S110).

When the measured value of the ESR for each sample frequency is not approximate to the calculated value (NO in step S110), CPU 102 varies the values of resistances R1, R2, inductance L1 and capacitance C1 of the equivalent circuit model (step S12).

The aforementioned steps S108, S110 and S112 are repeated until the measured value of the ESR for each sample frequency approximates to the calculated value in step S110.

When the measured value of the ESR for each sample frequency is approximate to the calculated value (YES in step S110), CPU 102 determines the values at that time as the values of resistances R1 and R2, inductance L1 and capacitance C1 of the equivalent circuit model (step S114).

The optimization process is as described above.

Thereafter, CPU 102 accepts a measured value of an impedance absolute value for a prescribed frequency input by the user (step S116). The user measures the impedance absolute value for the capacitor as an object for one prescribed frequency beforehand, and inputs the measured value using keyboard 116 and mouse 114.

Then, CPU 102 calculates inductance L2 (step S118). CPU 102 can calculate inductance L2 with expression (1) using the values of resistances R1, R2, R4, inductance L1 and capacitance C1 determined in the step above as well as the impedance absolute value for the prescribed frequency.

Finally, CPU 102 outputs the values of resistances R1, R2, R4, inductances L1, L2, and capacitance C1 to display 118 or the like (step S120).

The equivalent circuit model of the capacitor as an object can be derived with the above-described steps.

It is to be noted that, a nonlinear method of least squares is an example of a manner to vary the values of resistances R1 and R2, inductance L1 and capacitance C1 to approximate to the measured value of the ESR for each sample frequency. A Newton's method, a pattern method, a Gauss-Newton method and the like are known as representative algorithms of the nonlinear method of least squares.

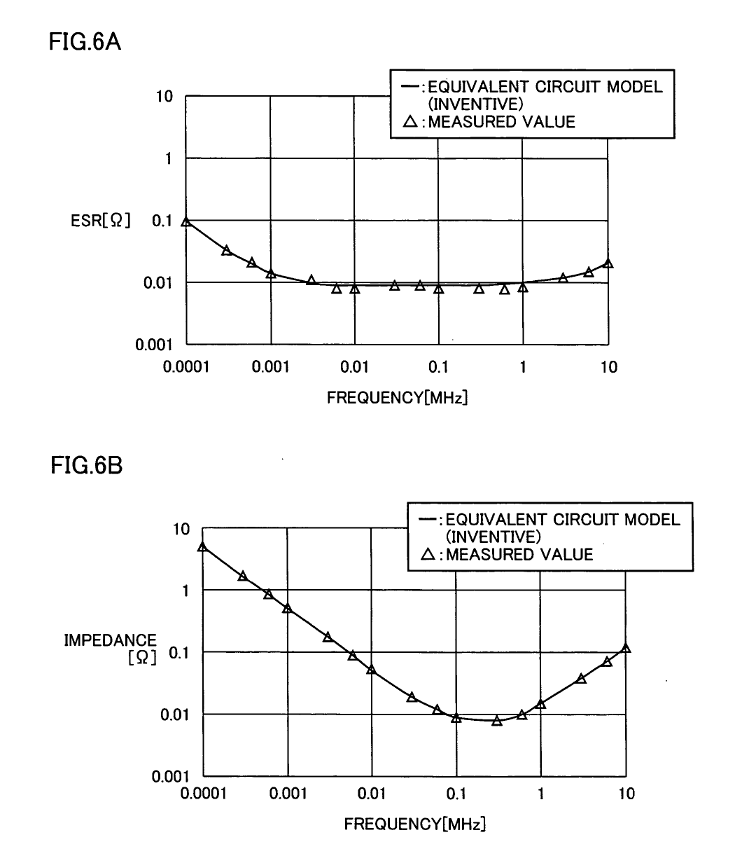

FIG. 6A shows a comparison of frequency characteristics of the ESR.

FIG. 6B shows a comparison of frequency characteristics of impedance absolute values.

Referring to FIGS. 6A and 6B, when the equivalent circuit model according to the first embodiment of the present invention is used, frequency characteristics of both of the ESR and impedance absolute values can be approximated to measured values.

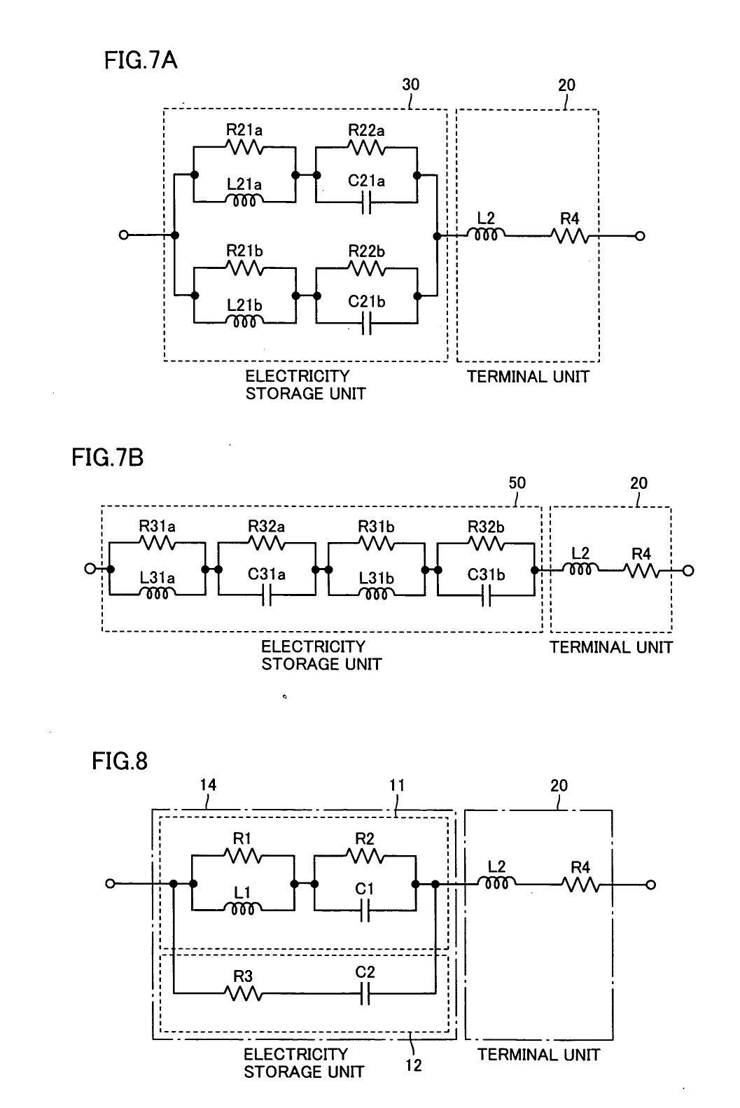

An equivalent circuit model as shown in FIG. 7A, which includes a circuit 30 corresponding to an electricity storage unit including two circuits 10 connected in parallel, or an equivalent circuit model as shown in FIG. 7B, which includes a circuit 50 corresponding to an electricity storage unit including two circuits 10 connected in series, can be used.

It is to be noted that, the record medium for storing the program is not limited to the CD-ROM or the hard disk, but it may be a flexible disk, a cassette tape, an optical disc (an MO (Magnetic Optical Disc)/an MD (Mini Disc)/a DVD (Digital Versatile Disc)), or a medium of a semiconductor memory such as an IC card (including a memory card), an optical memory card, a mask ROM, an EPROM, an EEPROM, or a flash ROM for fixedly carrying a program.

[Improved Example of First Embodiment]

Referring to FIG. 8, an equivalent circuit model according to an improved example of the first embodiment of the present invention consists of a circuit 14 corresponding to an electricity storage unit and circuit 20 corresponding to a terminal unit.

Circuit 14 includes a first series circuit 11 including a parallel circuit of resistance R1 and inductance L1 and a parallel circuit of resistance R2 and capacitance C1, which are connected in series with each other, and a second series circuit 12 including a resistance R3 and a capacitance C2 connected in series with each other. First series circuit 11 and second series circuit 12 are connected in parallel with each other.

Circuit 20 is formed with inductance L2 and resistance R4 connected in series.

The following expression (2) is an expression for calculating an impedance of the equivalent circuit model shown in FIG. 8.

$$Real part : \\ R4 + \frac{\begin{matrix}[ R1R2 ( 1 - {ω}^{2} C1L1 ) - {ω}^{2} C2L1R3 ( R1 + R2 ) ] \cdot \\ [ \begin{matrix}R1 - ω2 C1L1R2 - {ω}^{2} C2R3 \\ ( L1 + C1R1R2 ) - {ω}^{2} C2L1 ( R1 + R2 )\end{matrix} ] + \\ {ω}^{2} [ C2R1R2R3 ( 1 - {ω}^{2} C1L1 ) + L1 ( R1 + R2 ) ] \cdot \\ [ \begin{matrix}C2R3 ( R1 - {ω}^{2} C1L1R2 ) + L1 + \\ C1R1R2 + C2R1R2 ( 1 - {ω}^{2} C1L1 )\end{matrix} ]\end{matrix}}{\begin{matrix}{[ \begin{matrix}( R1 - {ω}^{2} C1L1R2 ) - {ω}^{2} C2R3 \\ ( L1 + C1R1R2 ) - {ω}^{2} C2L1 ( R1 + R2 )\end{matrix} ]}^{2} + \\ {{ω}^{2} [ \begin{matrix}C2R3 ( R1 - {ω}^{2} C1L1R2 ) + L1 + \\ C1R1R2 + C2R1R2 ( 1 - {ω}^{2} C1L1 )\end{matrix} ]}^{2}\end{matrix}} \\ Imaginary part : ω L2 + \frac{\begin{matrix}[ ω C2R1R2R3 ( 1 - {ω}^{2} C1L1 ) + ω L1 ( R1 + R2 ) ] \cdot \\ [ \begin{matrix}( R1 - {ω}^{2} C1L1R2 ) - {ω}^{2} C2R3 \\ ( L1 + C1R1R2 ) - {ω}^{2} C2L1 ( R1 + R2 )\end{matrix} ] - \\ [ R1R2 ( 1 - {ω}^{2} C1L1 ) - {ω}^{2} C2L1R3 ( R1 + R2 ) ] \cdot \\ [ \begin{matrix}ωC2R3 ( R1 - {ω}^{2} C1L1R2 ) + ω \\ ( L1 + C1R1R2 ) + ω C2R1R2 ( 1 - {ω}^{2} C1L1 )\end{matrix} ]\end{matrix}}{\begin{matrix}{[ \begin{matrix}( R1 - {ω}^{2} C1L1R2 ) - {ω}^{2} C2R3 \\ ( L1 + C1R1R2 ) - {ω}^{2} C2L1 ( R1 + R2 )\end{matrix} ]}^{2} + \\ {{ω}^{2} [ \begin{matrix}C2R3 ( R1 - {ω}^{2} C1L1R2 ) + L1 + \\ C1R1R2 + C2R1R2 ( 1 - {ω}^{2} C1L1 )\end{matrix} ]}^{2}\end{matrix}} \qquad [ Expression 2 ]$$

The equivalent circuit model according to the improved example of the first embodiment can correspond to a leakage current, one of properties of a capacitor, in addition to the ESR characteristic described above. The leakage current is measured using a current method or a voltage method with application of a constant DC voltage to the capacitor. Since a direct current flows through resistance R2 and inductance L1 in the equivalent circuit model shown in FIG. 8, only resistance R2 acts as a resistance component when the DC voltage is applied. Therefore, a value of R2 can be calculated with R2=V/I, where I represents the leakage current and V represents the applied DC voltage.

The value of R2 is relatively large because a value of the leakage current is usually as small as a few to a few hundred μA. Thus, second series circuit 12 is connected in parallel with first series circuit 11. With this, a current flowing through circuit 14 can be divided into first series circuit 11 and second series circuit 12, and the ESR value in the low frequency range, which varies with an increase in resistance R2, can be compensated.

Since circuit 20 is formed with inductance L2 and resistance R4 connected in series, an ESR thereof is R4 regardless of frequencies.

Therefore, the ESR characteristic can be approximated to measured values in the whole frequency range by, after determining resistance R4 using measured values in the whole frequency range, optimizing values of resistance R1 and inductance L1 mainly using measured values in the high frequency range and optimizing values of resistances R2, R3 and capacitances C1, C2 mainly using measured values in the low frequency range.

Next, a program for allowing a computer to execute derivation of the equivalent circuit model of the capacitor will be described.

The description of computer 100 for executing the program according to the improved example of the first embodiment of the present invention will not be repeated.

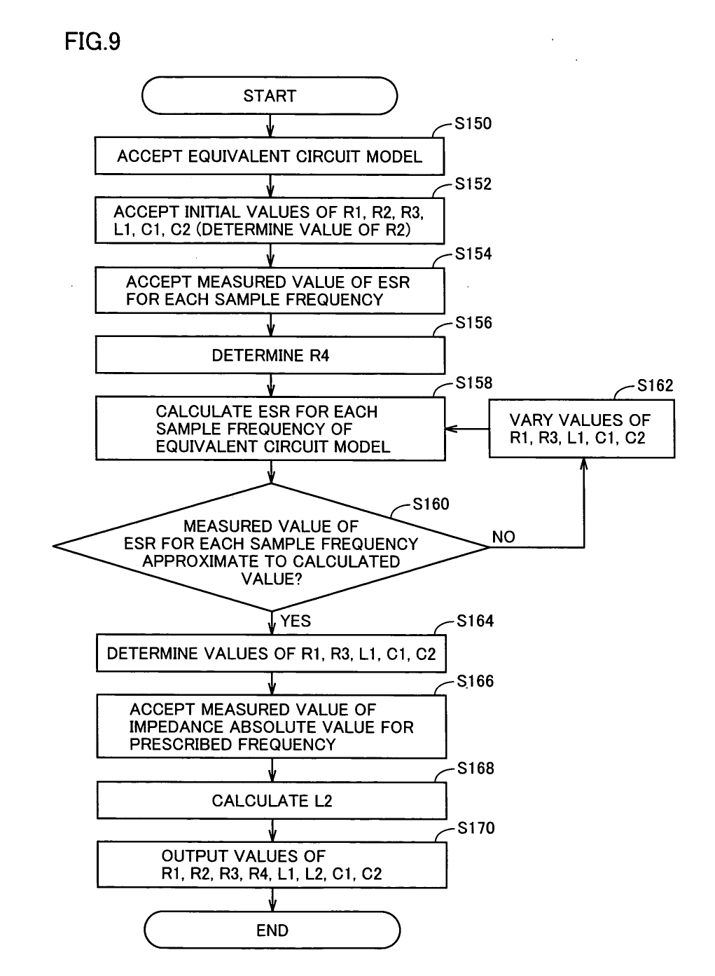

Computer 100 executes processing of each step shown in FIG. 9 with the program for deriving the equivalent circuit model executed in CPU 102.

Referring to FIG. 9, CPU 102 accepts an equivalent circuit model input by a user (step S150). The user allows the equivalent circuit model stored in CD-ROM 112 to be read from CD-ROM drive 110, and constructs the equivalent circuit model on display 118 using keyboard 116 and mouse 114.

Then, CPU 102 accepts initial values of resistances R1, R2, R3, inductance L1 and capacitances C1, C2 of the equivalent circuit model input by the user (step S152). The user inputs the initial values of resistances R1, R2, R3, inductance L1 and capacitances C1, C2 using keyboard 116 and mouse 114. The initial values are used in an optimization process described below, and can be arbitrarily determined by the user. CPU 102 can determine a value of R2 with R2=V/I, where I represents a leakage current and V represents an applied DC voltage.

CPU 102 further accepts a measured value of an ESR for each sample frequency input by the user (step S154). The user measures the ESR for each of a plurality of sample frequencies for the capacitor as an object beforehand and inputs the measured value using keyboard 116 and mouse 114. The larger a number of measured ESR is, the more accuracy of the equivalent circuit model increases.

After input from the user is completed, CPU 102 determines a value of resistance R4 (step S156). When a real part of expression (2) for calculation of the impedance, that is, the ESR is noted, R4 does not depend on Co. Therefore, resistance R4 can be calculated from the sample frequency and the measured ESR value.

Then, CPU 102 performs the optimization process for circuit 14 corresponding to the electricity storage unit to approximate an ESR frequency characteristic calculated using the equivalent circuit model to a measured ESR frequency characteristic. The optimization process will be described in the following.

CPU 102 calculates the ESR for each sample frequency of the equivalent circuit model corresponding to the sample frequency for which the ESR was measured (step S158).

Then, CPU 102 determines as to whether the measured value of the ESR for each sample frequency is approximate to the calculated value (step S160).

When the measured value of the ESR for each sample frequency is not approximate to the calculated value (NO in step S160), CPU 102 varies the values of resistances R1, R3, inductance L1 and capacitances C1, C2 of the equivalent circuit model (step S162).

The aforementioned steps S158, S160 and S162 are repeated until the measured value of the ESR for each sample frequency approximates to the calculated value in step S160.

When the measured value of the ESR for each sample frequency is approximate to the calculated value (YES in step S160), CPU 102 determines the values at that time as the values of resistances R1, R3, inductance L1 and capacitances C1, C2 of the equivalent circuit model (step S164).

The optimization process is as described above.

Thereafter, CPU 102 accepts a measured value of an impedance absolute value of a prescribed frequency input by the user (step S166). The user measures the impedance absolute value for one prescribed frequency for the capacitor as an object beforehand and inputs the measured value using keyboard 116 and mouse 114.

Then, CPU 102 calculates inductance L2 (step S168). CPU 102 can calculate inductance L2 with expression (2) using the values of resistances R1, R2, R3, inductance L1 and capacitance C1 determined in the step above as well as the impedance absolute value of the prescribed frequency.

Finally, CPU 102 outputs the values of resistances R1, R2, R3, R4, inductances L1, L2, and capacitances C1, C2 to display 118 or the like (step S170).

The equivalent circuit model of the capacitor as an object can be derived with the above-described steps.

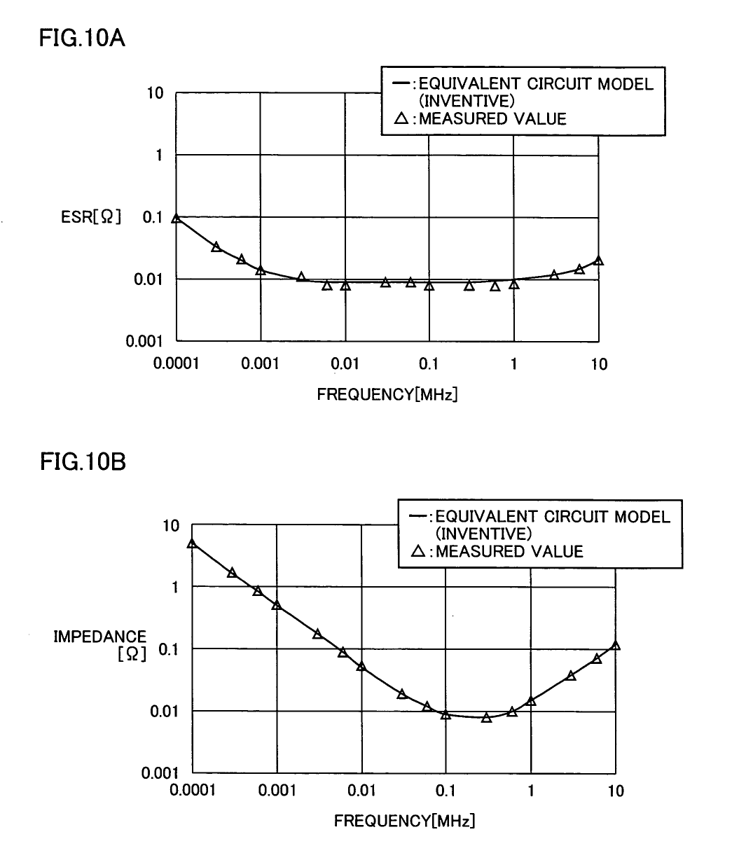

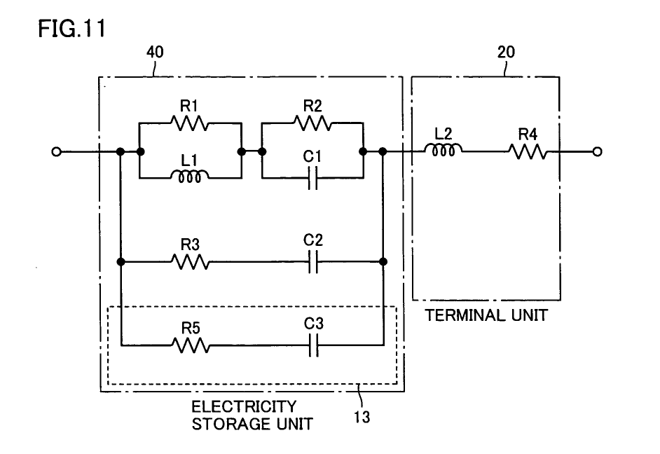

FIG. 10A shows a comparison of frequency characteristics of the ESR.

FIG. 10B shows a comparison of frequency characteristics of impedance absolute values.

Referring to FIGS. 10A and 10B, when the equivalent circuit model according to the improved example of the first embodiment of the present invention is used, frequency characteristics of both of the ESR and impedance absolute values can be approximated to measured values.

An equivalent circuit model including a circuit 40 corresponding to an electricity storage unit as shown in FIG. 111 can be used, which circuit 40 is formed with connecting a third series circuit 13, including a resistance R5 and a capacitance C3 connected in series, in parallel with circuit 14 of FIG. 8 corresponding to an electricity storage unit.

### Second Embodiment

A program for allowing a computer to execute a simulation of electric characteristics of an electric circuit having a capacitor according to a second embodiment of the present invention will now be described.

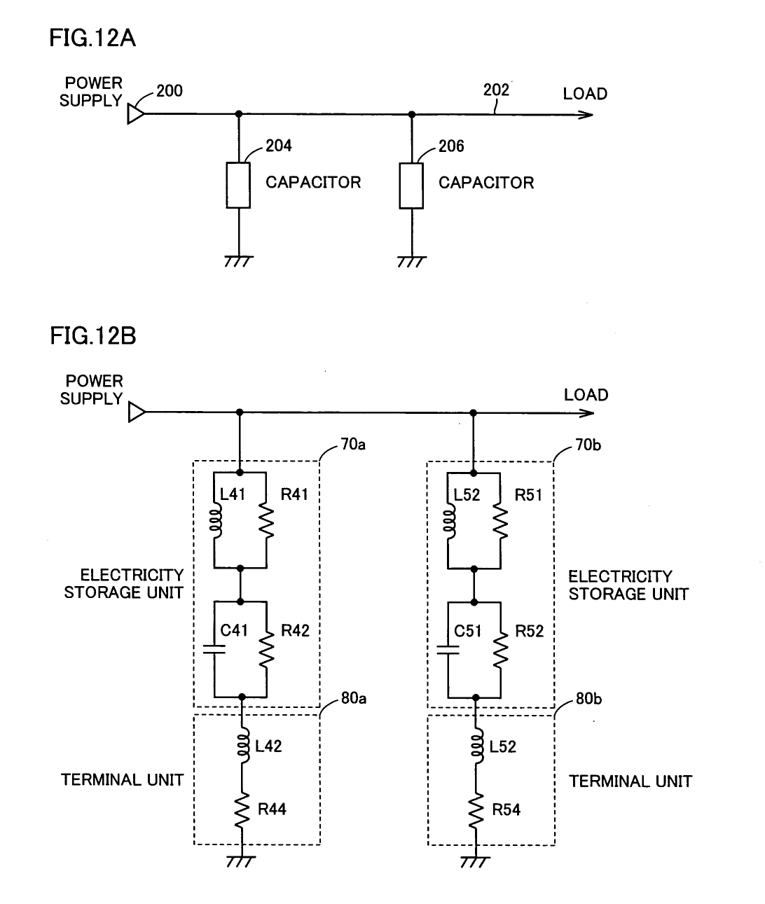

FIG. 12A shows a construction of a power supply decoupling circuit.

FIG. 12B shows a circuit model of a power supply decoupling circuit.

A power supply decoupling circuit is generally used as a noise filter of a power supply. FIG. 12A shows a power supply decoupling circuit formed with two capacitors.

FIG. 12B shows a circuit model constructed from the power supply decoupling circuit shown in FIG. 12A using the equivalent circuit model shown in FIG. 3.

Computer 100 for executing the process is described above in detail, and therefore the description thereof will not be repeated.

A user derives equivalent circuit models of capacitors 204, 206 shown in FIG. 12A beforehand with the program according to the first embodiment described above or the like.

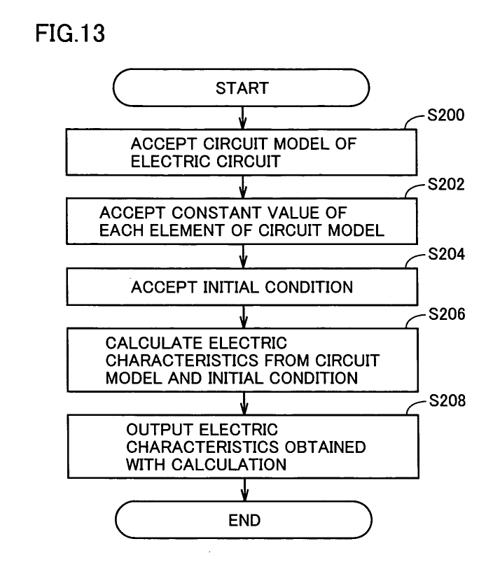

Referring to FIG. 13, CPU 102 accepts a circuit model of an electric circuit input by a user (step S200). The user constructs the circuit model as shown in FIG. 12B on display 118 using keyboard 116 and mouse 114.

Then, CPU 102 accepts a constant value of each element of the circuit model (step S202). The user inputs values of resistances R41, R42, R43, inductances L41, L42, a capacitance C41, resistances R51, R52, R53, inductances L51, L52, and a capacitance C51 shown in FIG. 12B using keyboard 116 and mouse 114.

CPU 102 further accepts an initial condition of the simulation (step S204). The user uses keyboard 116 and mouse 114 to input as the initial condition a frequency range, an input signal waveform or the like for obtaining desired electric characteristics.

When it is desired to perform a simulation of a frequency characteristic of transfer from a power supply side to a load side in FIG. 12B, for example, a frequency range of a signal applied from the power supply side is input as the initial condition.

CPU 102 calculates the electric characteristics from the circuit model and the initial condition accepted (step S206). A nodal analysis method based on Kirchhoffs law is known as a manner of calculation.

Thereafter, CPU 102 outputs the electric characteristics obtained with the calculation to display 118 or the like (step S208).

It is to be noted that, the user can store the electric characteristics obtained with the calculation as electronic data in hard disk 108 or the like.

With the steps described above, a simulation of the electric characteristics of the electric circuit as an object can be performed using the equivalent circuit model of the capacitor.

[Improved Example of Second Embodiment]

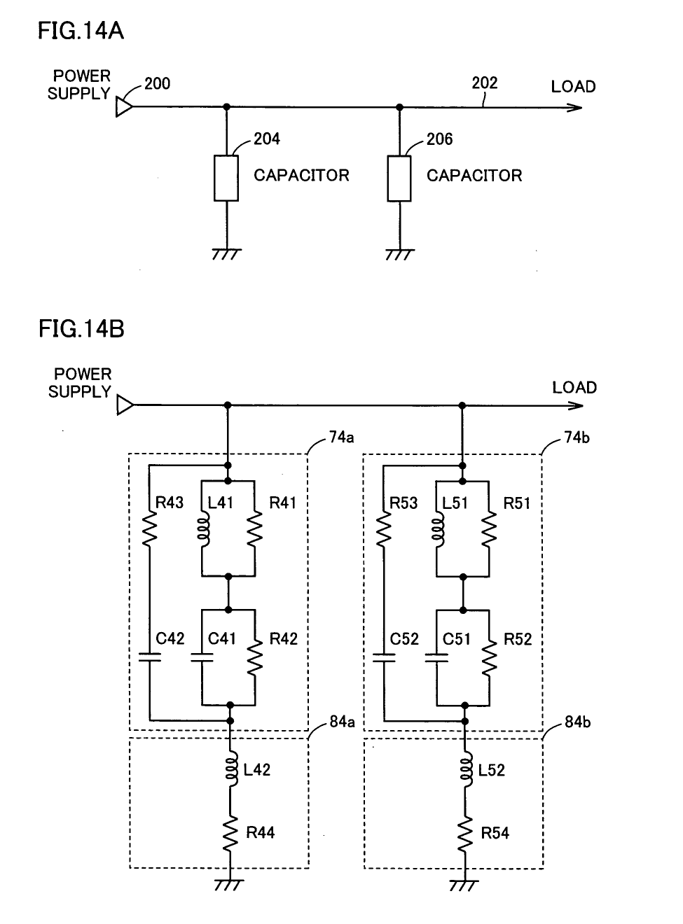

FIG. 14A shows a construction of a power supply decoupling circuit.

FIG. 14B shows a circuit model of a power supply decoupling circuit.

A power supply decoupling circuit is generally used as a noise filter of a power supply. FIG. 14A shows a power supply decoupling circuit formed with two capacitors.

FIG. 14B shows a circuit model constructed from the power supply decoupling circuit shown in FIG. 14A using the equivalent circuit model shown in FIG. 8.

A flow chart of the program for performing a simulation of the electric circuit having the capacitor according to an improved example of the second embodiment of the present invention is similar to FIG. 13 described above.

A user derives equivalent circuit models of capacitors 204, 206 shown in FIG. 14A beforehand with the program according to the improved example of the first embodiment of the present invention or the like.

Referring to FIG. 13, CPU 102 accepts a circuit model of an electric circuit input by a user (step S200). The user constructs the circuit model as shown in FIG. 14B on display 118 using keyboard 116 and mouse 114.

Then, CPU 102 accepts a constant value of each element of the circuit model (step S202). The user inputs values of resistances R41, R42, R43, R44, inductances L41, L42, capacitances C41, C42, resistances R51, R52, R53, R54, inductances L51, L52, and capacitances C51, C52 shown in FIG. 14B using keyboard 116 and mouse 114. Since the following steps are similar to those described in the second embodiment, the descriptions thereof will not be repeated.

### Third Embodiment

A method of designing a capacitor according to a third embodiment of the present invention will now be described.

As an example, in the decoupling circuit shown in FIG. 12A, parallel resonance is sometimes produced between capacitor 204 and capacitor 206. A situation will be described in which capacitor 204 is newly designed to avoid the parallel resonance.

The equivalent circuit model shown in FIG. 3 is adopted as an equivalent circuit model of the capacitor.

Computer 100 for executing the process is described above in detail, and therefore the description thereof will not be repeated.

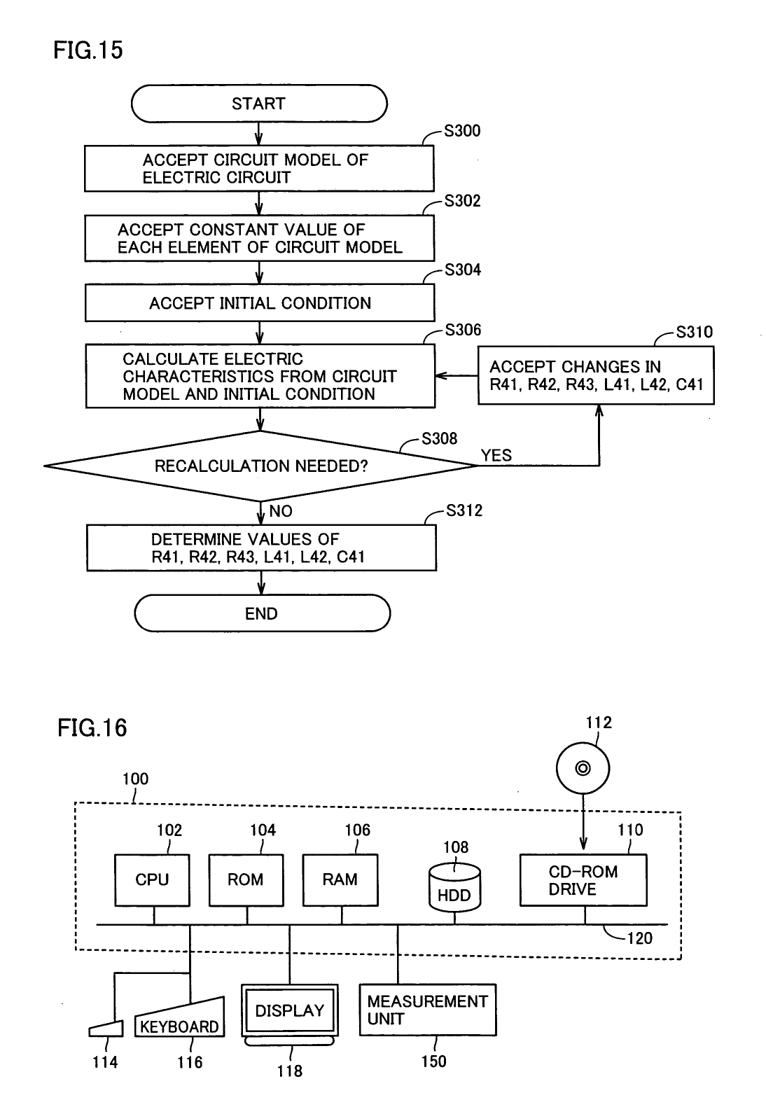

First, a user executes the process shown in FIG. 15 with the computer to derive a desired capacitor characteristic.

Referring to FIG. 15, CPU 102 accepts a circuit model of an electric circuit including an equivalent circuit of a capacitor input by a user (step S300). The user constructs the circuit model as shown in FIG. 12B on display 118 using keyboard 116 and mouse 114.

Then, CPU 102 accepts a constant value of each element of the circuit model (step S302). The user inputs values of resistances R41, R42, R43, inductances L41, L42, capacitance C41, resistances R51, R52, R53, inductances L51, L52, and capacitance C51 shown in FIG. 12B using keyboard 116 and mouse 114.

CPU 102 further accepts an initial condition of the simulation input by the user (step S304). The user inputs as the initial condition a frequency range, an input signal waveform or the like for obtaining desired electric characteristics using keyboard 116 and mouse 114. The user inputs, for example, a frequency range for performing a simulation of a transfer function from a power supply side.

CPU 102 then calculates the electric characteristics from the circuit model and the initial condition accepted (step S306).

Thereafter, CPU 102 accepts as to whether a recalculation is needed or not (step S308). When the calculated electric characteristics are not the desired electric characteristics, the user inputs that the recalculation is needed.

When the recalculation is needed (YES in step S308), CPU 102 accepts changes in values of resistances R41, R42, R43, inductances L41, L42, and capacitance C41 of the equivalent circuit model (step S310). The user optionally changes and inputs the values of resistances R41, R42, R43, inductances L41, L42, and capacitance C41.

Thereafter, the above-described steps S306, S308 and S310 are repeated until the recalculation is not needed in step S308.

When the desired electric characteristics are obtained and the recalculation is not needed (NO in step S308), the user determines the values of resistances R41, R42, R43, inductances L41, L42, and capacitance C41 as new design values (step S312).

An optimization process is as described above.

The user can obtain an equivalent circuit model of a new capacitor by performing the aforementioned process with the computer.

Then, the user compares the equivalent circuit model of capacitor 204 with the equivalent circuit model of the new capacitor.

When there is a change in a circuit 70a corresponding to an electricity storage unit in FIG. 12B, that is, resistances R41, R42, inductance L41, and capacitance C41, design of the electricity storage unit of the capacitor will be changed.

In addition, when there is a change in a circuit 80a corresponding to a terminal unit in FIG. 12B, that is, resistance R43 and inductance L42, design of the terminal unit of the capacitor will be changed.

As described above, since a portion requiring a change in design can be specified, efficient designing is enabled.

More preferably, since an actual terminal unit is generally divided into an anode portion and a cathode portion, resistance R43 and inductance L42 forming the circuit corresponding to the terminal unit can further be divided for designing by an electromagnetic analysis of structures of the anode and cathode portions.

It is known to perform the electromagnetic analysis with an algorithm such as an FDTD method or a moment method using a computer.

In addition, electric characteristics of the new capacitor having a changed design can be ensured with the equivalent circuit model derived by executing the program described in the first embodiment of the present invention.

### Fourth Embodiment

An apparatus for making a conforming/nonconforming decision for a capacitor according to a fourth embodiment of the present invention will now be described.

Referring to FIG. 16, the apparatus for making a conforming/nonconforming decision for a capacitor includes a microcomputer 100, mouse 114, keyboard 116, display 118, and a measurement unit 150.

Since microcomputer 100, mouse 114, keyboard 116, and display 118 are similar to those described above, the descriptions thereof will not be repeated.

Measurement unit 150, in accordance with a command from CPU 102, measures an ESR and an impedance absolute value for any sample frequency and transfers measurement data thereof to RAM 106. Measurement unit 150 measures the ESR and impedance absolute value with vector arithmetic of an applied alternative voltage waveform and an alternative current waveform, which is a well-known technique and therefore a detailed description thereof is not given here.

In the fourth embodiment of the present invention, the equivalent circuit model shown in FIG. 3 is adopted as the equivalent circuit model of the capacitor.

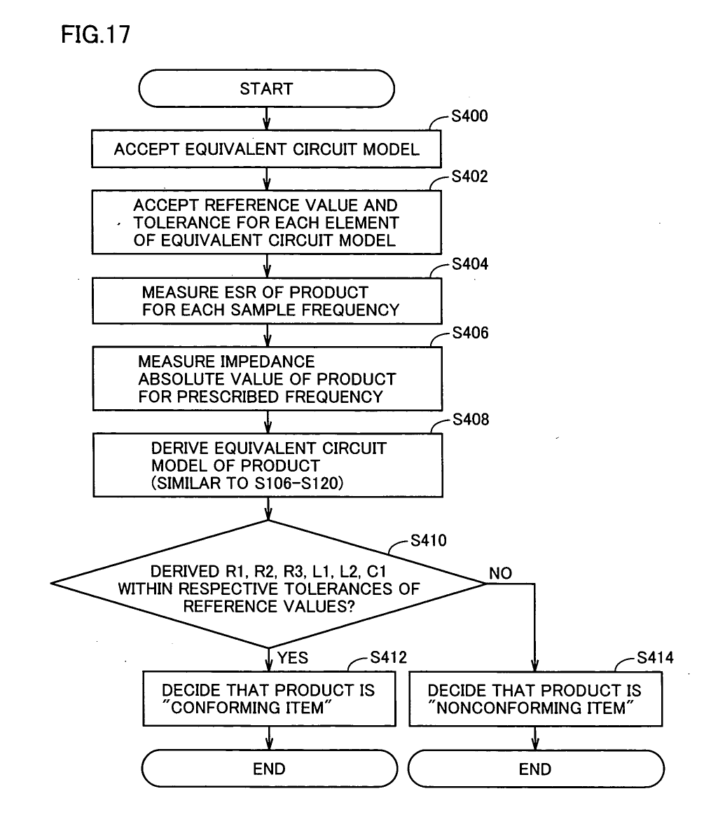

Referring to FIG. 17, CPU 102 accepts an equivalent circuit model input by a user. The user determines the equivalent circuit model using keyboard 116 and mouse 114 (step S400).

Then, CPU 102 accepts a reference value and a tolerance for each element of the determined equivalent circuit model input by the user (step S402). The user inputs reference values and tolerances for allowing a decision of a conforming item for resistances R1, R2, R3, inductances L1, L2, and capacitance C1 using keyboard 116 and mouse 114.

Next, measurement unit 150 measures an ESR of a product for each of a plurality of sample frequencies in accordance with a command from CPU 102 (step S404), and transfers data thereof to RAM 106.

Furthermore, measurement unit 150 measures an impedance absolute value of the product for a prescribed frequency in accordance with a command from CPU 102 (step S406), and transfers data thereof to RAM 106.

CPU 102 derives an equivalent circuit model of the product (step S408). Since this step is similar to steps S106, S108, S110, S112, S114, S116, S118, and S120 shown in FIG. 5 in the first embodiment of the present invention, a detailed description thereof is not repeated here.

Thereafter, CPU 102 determines as to whether derived resistances R1, R2, R3, inductances L1, L2, and capacitance C1 are within respective tolerances of reference values or not (step S410).

When all values are within the tolerances of the reference values (YES in step S410), CPU 102 decides that the product is a “conforming item” (step S412).

On the other hand, when any of the values is not within the tolerance of the reference value (NO in step S410), CPU 102 decides that the product is a “nonconforming item” (step S414).

As described above, the conforming/nonconforming decision for the product can be made using the equivalent circuit model derived from the ESR for each sample frequency.

It is to be noted that, though the apparatus formed with computer 100 including measurement unit 150 is described in the fourth embodiment of the present invention, the apparatus is not limited to this and the user may measure an ESR and an impedance absolute value of a product, and then input data thereof to an apparatus for performing a similar process.

[Improved Example of Fourth Embodiment]

Since the apparatus for making a conforming/nonconforming decision for a capacitor is described above, the description thereof will not be repeated here.

In an improved example of the fourth embodiment of the present invention, the equivalent circuit model shown in FIG. 8 is adopted as the equivalent circuit model of the capacitor.

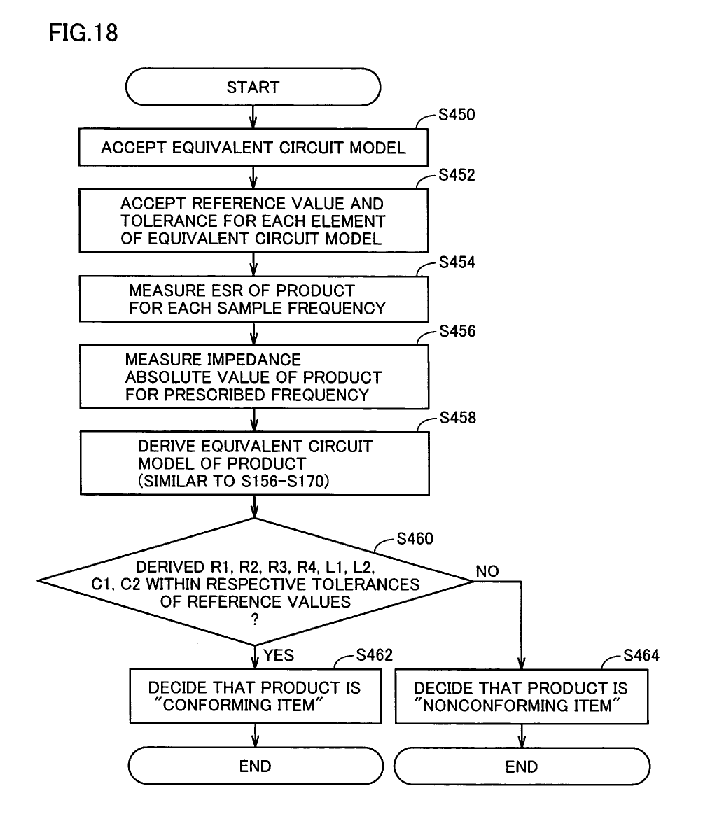

Referring to FIG. 18, CPU 102 accepts an equivalent circuit model input by a user. The user determines the equivalent circuit model using keyboard 116 and mouse 114 (step S450).

Then, CPU 102 accepts a reference value and a tolerance for each element of the determined equivalent circuit model input by the user (step S452). The user inputs reference values and tolerances for allowing a decision of a conforming item for resistances R1, R2, R3, R4, inductances L1, L2, and capacitances C1, C2 using keyboard 116 and mouse 114.

Next, measurement unit 150 measures an ESR of a product for each of a plurality of sample frequencies in accordance with a command from CPU 102 (step S454), and transfers data thereof to RAM 106.

Furthermore, measurement unit 150 measures an impedance absolute value of the product for a prescribed frequency in accordance with a command from CPU 102 (step S456), and transfers data thereof to RAM 106.

CPU 102 derives an equivalent circuit model of the product (step S458). Since this step is similar to steps S156, S158, S160, S162, S164, S166, S168, and S170 shown in FIG. 9 in the improved example of the first embodiment of the present invention, a detailed description thereof is not given here.

Thereafter, CPU 102 determines as to whether derived resistances R1, R2, R3, R4, inductances L1, L2, and capacitances C1, C2 are within respective tolerances of reference values or not (step S460).

When all values are within the tolerances of the reference values (YES in step S460), CPU 102 decides that the product is a “conforming item” (step S462).

On the other hand, when any of the values is not within the tolerance of the reference value (NO in step S460), CPU 102 decides that the product is a “nonconforming item” (step S464).

As described above, the conforming/nonconforming decision for the product can be made using the equivalent circuit model derived from the ESR for each sample frequency.

Although the present invention has been described and illustrated in detail, it is clearly understood that the same is by way of illustration and example only and is not to be taken by way of limitation, the spirit and scope of the present invention being limited only by the terms of the appended claims.

1. A computer-readable record medium recording an equivalent circuit model of an electricity storage element wherein a real part of an equivalent impedance varies to approximate to a real part of a measured impedance according to a frequency of an applied AC signal; wherein
said equivalent circuit model includes
a first circuit corresponding to an electricity storage unit and
a second circuit corresponding to a terminal unit and connected in series with said first circuit;
said first circuit includes
at least one first series circuit including a first parallel circuit and a second parallel circuit connected in series;
said first parallel circuit includes
a first resistance and
a first inductance connected in parallel with said first resistance; and
said second parallel circuit includes
a second resistance and
a first capacitance connected in parallel with said second resistance.

2. The computer-readable record medium recording an equivalent circuit model according to claim 1, wherein
said first circuit includes one said first series circuit.

3. The computer-readable record medium recording an equivalent circuit model according to claim 2, wherein
said first circuit further includes a second series circuit connected in parallel with said first series circuit, and
said second series circuit includes
a third resistance and
a second capacitance connected in series with said third resistance.

4. The computer-readable record medium recording an equivalent circuit model according to claim 1, wherein
said second circuit includes
a second inductance and
a fourth resistance connected in series with said second inductance.

5. A program to be executed by a computer for derivation of an equivalent circuit model of an electricity storage element wherein a real part of an equivalent impedance varies to approximate to a real part of a measured impedance according to a frequency of an applied AC signal; wherein
said equivalent circuit model includes
a first circuit corresponding to an electricity storage unit and
a second circuit corresponding to a terminal unit and connected in series with said first circuit;
said first circuit includes
at least one first series circuit including a first parallel circuit and a second parallel circuit connected in series;
said first parallel circuit includes
a first resistance and
an inductance connected in parallel with said first resistance;
said second parallel circuit includes
a second resistance and
a first capacitance connected in parallel with said second resistance; and
said program allows a computer to execute the steps of
accepting a frequency characteristic of the real part of the measured impedance of said electricity storage element and
optimizing each value of an element forming said first circuit to approximate a frequency characteristic of the real part of the equivalent impedance of said equivalent circuit model to the frequency characteristic of the real part of said measured impedance.

6. The program to be executed by a computer according to claim 5, wherein
said step of optimizing includes
a first step of varying respective values of said first resistance, said second resistance, said inductance and said first capacitance,
a second step of calculating a frequency characteristic of the real part of the equivalent impedance of said equivalent circuit model using varied values of said first resistance, said second resistance, said inductance and said first capacitance, and
a third step of repeating said first step and said second step until a calculated frequency characteristic of the real part of the equivalent impedance approximates to the frequency characteristic of the real part of the measured impedance of said electricity storage element.

7. The program to be executed by a computer according to claim 5, wherein
said first circuit includes
one said first series circuit and
a second series circuit connected in parallel with said first series circuit,
said second series circuit includes
a third resistance and
a second capacitance connected in series with said third resistance, and
said step of optimizing includes
a first step of varying respective values of said first resistance, said second resistance, said third resistance, said inductance, said first capacitance, and said second capacitance,
a second step of calculating a frequency characteristic of the real part of the equivalent impedance of said equivalent circuit model using varied values of said first resistance, said second resistance, said third resistance, said inductance, said first capacitance, and said second capacitance, and
a third step of repeating said first step and said second step until a calculated frequency characteristic of the real part of the equivalent impedance approximates to the frequency characteristic of the real part of the measured impedance of said electricity storage element.

8. A computer-readable record medium recording the program according to claim 5.

9. A program to be executed by a computer for a simulation of electric characteristics of an electric circuit having an electricity storage element using an equivalent circuit model of said electricity storage element wherein a real part of an equivalent impedance varies to approximate to a real part of a measured impedance according to a frequency of an applied AC signal; wherein
said equivalent circuit model includes
a first circuit corresponding to an electricity storage unit and
a second circuit corresponding to a terminal unit and connected in series with said first circuit;
said first circuit includes
at least one first series circuit including a first parallel circuit and a second parallel circuit connected in series;
said first parallel circuit includes
a first resistance and
an inductance connected in parallel with said first resistance;
said second parallel circuit includes
a second resistance and
a first capacitance connected in parallel with said second resistance; and
said program allows a computer to execute the steps of
accepting a circuit model of said electric circuit including the equivalent circuit model of said electricity storage element,
accepting a simulation condition,
calculating said electric characteristics based on the circuit model of said electric circuit and the simulation condition, and
outputting calculated electric characteristics.

10. The program to be executed by a computer according to claim 9, wherein
said first circuit includes
one said first series circuit and
a second series circuit connected in parallel with said first series circuit, and
said second series circuit includes
a third resistance and
a second capacitance connected in series with said third resistance.

11. A computer-readable record medium recording the program according to claim 9.

12. A method of designing an electricity storage element to set electric characteristics of an electric circuit having said electricity storage element to desired electric characteristics using an equivalent circuit model of said electricity storage element wherein a real part of an equivalent impedance varies to approximate to a real part of a measured impedance according to a frequency of an applied AC signal; wherein
said equivalent circuit model includes
a first circuit corresponding to an electricity storage unit and
a second circuit corresponding to a terminal unit and connected in series with said first circuit;
said first circuit includes
at least one first series circuit including a first parallel circuit and a second parallel circuit connected in series;
said first parallel circuit includes
a first resistance and
an inductance connected in parallel with said first resistance;
said second parallel circuit includes
a second resistance and
a first capacitance connected in parallel with said second resistance; and
said method comprising the steps of:
making a circuit model of said electric circuit including the equivalent circuit model of said electricity storage element;
determining said desired electric characteristics;
optimizing each value of an element forming said first circuit to approximate the electric characteristics of the circuit model of said electric circuit to said desired electric characteristics; and
fabricating said electricity storage element based on each optimized value of the element forming said first circuit.

13. The method of designing an electricity storage element according to claim 12, wherein
said step of optimizing includes
a first step of varying respective values of said first resistance, said second resistance, said inductance and said first capacitance,
a second step of calculating the electric characteristics of the circuit model of said electric circuit using varied values of said first resistance, said second resistance, said inductance and said first capacitance, and
a third step of repeating said first step and said second step until calculated electric characteristics of the circuit model of said electric circuit approximate to said desired electric characteristics.

14. The method of designing an electricity storage element according to claim 12, wherein
said first circuit includes
one said first series circuit and
a second series circuit connected in parallel with said first series circuit,
said second series circuit includes
a third resistance and
a second capacitance connected in series with said third resistance, and
said step of optimizing includes
a first step of varying respective values of said first resistance, said second resistance, said third resistance, said inductance, said first capacitance, and said second capacitance,
a second step of calculating the electric characteristics of the circuit model of said electric circuit using varied values of said first resistance, said second resistance, said third resistance, said inductance, said first capacitance, and said second capacitance, and
a third step of repeating said first step and said second step until calculated electric characteristics of the circuit model of said electric circuit approximate to said desired electric characteristics.

15. A method of making a conforming/nonconforming decision for an electricity storage element using an equivalent circuit model of said electricity storage element wherein a real part of an equivalent impedance varies to approximate to a real part of a measured impedance according to a frequency of an applied AC signal; wherein
said equivalent circuit model includes
a first circuit corresponding to an electricity storage unit and
a second circuit corresponding to a terminal unit and connected in series with said first circuit;
said first circuit includes
at least one first series circuit including a first parallel circuit and a second parallel circuit connected in series;
said first parallel circuit includes
a first resistance and
an inductance connected in parallel with said first resistance;
said second parallel circuit includes
a second resistance and
a first capacitance connected in parallel with said second resistance; and
said method comprising the steps of:
obtaining a frequency characteristic of the real part of the measured impedance of said electricity storage element;
optimizing each value of an element forming said first circuit to approximate a frequency characteristic of the real part of the equivalent impedance of said equivalent circuit model to the frequency characteristic of the real part of said measured impedance; and
deciding that said electricity storage element is a conforming item if each optimized value of the element forming said first circuit is within a predetermined range.

16. The method of making a conforming/nonconforming decision for an electricity storage element according to claim 15, wherein
said step of optimizing includes
a first step of varying respective values of said first resistance, said second resistance, said inductance and said first capacitance,
a second step of calculating a frequency characteristic of the real part of the equivalent impedance of said equivalent circuit model using varied values of said first resistance, said second resistance, said inductance and said first capacitance, and
a third step of repeating said first step and said second step until a calculated frequency characteristic of the real part of the equivalent impedance approximates to the frequency characteristic of the real part of the measured impedance of said electricity storage element.

17. The method of making a conforming/nonconforming decision for an electricity storage element according to claim 15, wherein
said first circuit includes
one said first series circuit and
a second series circuit connected in parallel with said first series circuit,
said second series circuit includes
a third resistance and
a second capacitance connected in series with said third resistance, and
said step of optimizing includes
a first step of varying respective values of said first resistance, said second resistance, said third resistance, said inductance, said first capacitance, and said second capacitance,
a second step of calculating a frequency characteristic of the real part of the equivalent impedance of said equivalent circuit model using varied values of said first resistance, said second resistance, said third resistance, said inductance, said first capacitance, and said second capacitance, and
a third step of repeating said first step and said second step until a calculated frequency characteristic of the real part of the equivalent impedance approximates to the frequency characteristic of the real part of the measured impedance of said electricity storage element.

18. An apparatus for deriving an equivalent circuit model of an electricity storage element wherein a real part of an equivalent impedance varies to approximate to a real part of a measured impedance according to a frequency of an applied AC signal; wherein
said equivalent circuit model includes
a first circuit corresponding to an electricity storage unit and
a second circuit corresponding to a terminal unit and connected in series with said first circuit;
said first circuit includes
at least one first series circuit including a first parallel circuit and a second parallel circuit connected in series;
said first parallel circuit includes
a first resistance and
an inductance connected in parallel with said first resistance;
said second parallel circuit includes
a second resistance and
a first capacitance connected in parallel with said second resistance; and
said apparatus comprising:
a portion for accepting a frequency characteristic of the real part of the measured impedance of said electricity storage element; and
a portion for optimizing each value of an element forming said first circuit to approximate a frequency characteristic of the real part of the equivalent impedance of said equivalent circuit model to the frequency characteristic of the real part of said measured impedance.

19. The apparatus for deriving an equivalent circuit model according to claim 18, wherein
said portion for optimizing includes
a first portion for varying respective values of said first resistance, said second resistance, said inductance and said first capacitance and
a second portion for calculating a frequency characteristic of the real part of the equivalent impedance of said equivalent circuit model using varied values of said first resistance, said second resistance, said inductance and said first capacitance, and
said first portion and said second portion repeat operations until a calculated frequency characteristic of the real part of the equivalent impedance approximates to the frequency characteristic of the real part of the measured impedance of said electricity storage element.

20. The apparatus for deriving an equivalent circuit model according to claim 18, wherein
said first circuit includes
one said first series circuit and
a second series circuit connected in parallel with said first series circuit,
said second series circuit includes
a third resistance and
a second capacitance connected in series with said third resistance, and
said portion for optimizing includes
a first portion for varying respective values of said first resistance, said second resistance, said third resistance, said inductance, said first capacitance, and said second capacitance and
a second portion for calculating a frequency characteristic of the real part of the equivalent impedance of said equivalent circuit model using varied values of said first resistance, said second resistance, said third resistance, said inductance, said first capacitance, and said second capacitance, and
said first portion and said second portion repeat operations until a calculated frequency characteristic of the real part of the equivalent impedance approximates to the frequency characteristic of the real part of the measured impedance of said electricity storage element.

21. An apparatus for performing a simulation of electric characteristics of an electric circuit having an electricity storage element using an equivalent circuit model of said electricity storage element wherein a real part of an equivalent impedance varies to approximate to a real part of a measured impedance according to a frequency of an applied AC signal; wherein
said equivalent circuit model includes
a first circuit corresponding to an electricity storage unit and
a second circuit corresponding to a terminal unit and connected in series with
said first circuit;
said first circuit includes at least one first series circuit including a first parallel circuit and a second parallel circuit connected in series;
said first parallel circuit includes
a first resistance and
an inductance connected in parallel with said first resistance;
said second parallel circuit includes
a second resistance and
a capacitance connected in parallel with said second resistance; and
said apparatus comprising:
a portion for accepting a circuit model of said electric circuit including said equivalent circuit model;
a portion for accepting a simulation condition;
a portion for calculating said electric characteristics based on the circuit model of said electric circuit and the simulation condition; and
a portion for outputting calculated electric characteristics.

22. The apparatus for performing a simulation of electric characteristics according to claim 21, wherein
said first circuit includes
one said first series circuit and
a second series circuit connected in parallel with said first series circuit, and
said second series circuit includes
a third resistance and
a second capacitance connected in series with said third resistance.

23. An apparatus for making a conforming/nonconforming decision for an electricity storage element using an equivalent circuit model of said electricity storage element wherein a real part of an equivalent impedance varies to approximate to a real part of a measured impedance according to a frequency of an applied AC signal; wherein
said equivalent circuit model includes
a first circuit corresponding to an electricity storage unit and
a second circuit corresponding to a terminal unit and connected in series with said first circuit;
said first circuit includes
at least one first series circuit including a first parallel circuit and a second parallel circuit connected in series;
said first parallel circuit includes
a first resistance and
an inductance connected in parallel with said first resistance;
said second parallel circuit includes
a second resistance and
a first capacitance connected in parallel with said second resistance; and
said apparatus comprising:
a portion for obtaining a frequency characteristic of the real part of the measured impedance of said electricity storage element;
a portion for optimizing each value of an element forming said first circuit to approximate a frequency characteristic of the real part of the equivalent impedance of said equivalent circuit model to the frequency characteristic of the real part of said measured impedance; and
a portion for deciding that said electricity storage element is a conforming item if each optimized value of the element forming said first circuit is within a predetermined range.

24. The apparatus for making a conforming/nonconforming decision for an electricity storage element according to claim 23, wherein
said portion for optimizing includes
a first portion for varying respective values of said first resistance, said second resistance, said inductance and said first capacitance and
a second portion for calculating a frequency characteristic of the real part of the equivalent impedance of said equivalent circuit model using varied values of said first resistance, said second resistance, said inductance and said first capacitance, and
said first portion and said second portion repeat operations until a calculated frequency characteristic of the real part of the equivalent impedance approximates to the frequency characteristic of the real part of the measured impedance of said electricity storage element.

25. The apparatus for making a conforming/nonconforming decision for an electricity storage element according to claim 23, wherein
said first circuit includes
one said first series circuit and
a second series circuit connected in parallel with said first series circuit,
said second series circuit includes
a third resistance and
a second capacitance connected in series with said third resistance, and
said portion for optimizing includes
a first portion for varying respective values of said first resistance, said second resistance, said third resistance, said inductance, said first capacitance, and said second capacitance and
a second portion for calculating a frequency characteristic of the real part of the equivalent impedance of said equivalent circuit model using varied values of said first resistance, said second resistance, said third resistance, said inductance, said first capacitance, and said second capacitance, and
said first portion and said second portion repeat operations until a calculated frequency characteristic of the real part of the equivalent impedance approximates to the frequency characteristic of the real part of the measured impedance of said electricity storage element.
